(19) United States
(12) Patent Application Publication
(10) Pub. No.: US 2024/0052196 A1
(43) Pub. Date: Feb. 15, 2024

(54) PROCESS FOR PROVIDING LOW GLOSS COATINGS

(71) Applicant: Covestro (Netherlands) B.V., Geleen (NL)

(72) Inventors: Johannes Jacobus Julius VAN DEN BIGGELAAR, Raamsdonksveer (NL); Michael Christopher VILLET, Maastricht (NL); Johan Franz Gradus Antonius JANSEN, Geleen (NL); Marco Marcus Matheus DRIESSEN, Maastricht (NL); Huimin CAO, Naperville, IL (US); Johannes Hendricus GROEN, Amersfoort (NL)

(21) Appl. No.: 18/547,212

(22) PCT Filed: Feb. 18, 2022
(86) PCT No.: PCT/EP2022/054153

§ 371 Date: Aug. 21, 2023

(30) Foreign Application Priority Data
Feb. 22, 2021 (EP) 21158349.7

(51) Int. Cl. C09D 175/06; C09D 5/00

(52) U.S. Cl. CPC C09D 175/06; C09D 5/006

(57) ABSTRACT

The present invention is directed to a process for producing a coating, wherein the process comprises
(1) Irradiating a radiation-curable coating composition with UV light having a wavelength ≤220 nm under inert gas, followed by
(2) Irradiating with UV light having a wavelength ≥300 nm or with E-beam, wherein the radiation-curable coating composition comprises
(A) One or more oligomeric urethane acrylates (A) with a molar mass of from 1100 to 5000 g/mol with an acrylate functionality of from 4 to 14, and
(B) One or more acrylate diluents (B) with a molar mass less than 650 g/mol and with an acrylate functionality of from 2 to 4, and
   wherein
   the amount of (A) is from 20 to 75 wt. % and the amount of (B) is from 25 to 80 wt. %, based on the total amount of (A) and (B), and
   the total amount of (A) and (B) is at least 50 wt. % by weight of the radiation-curable coating composition.

The present invention relates to the field of radiation curable coating compositions for coating a substrate in order to provide it with a low gloss coating. The present invention also relates to a process for producing a low gloss coating from a radiation-curable coating composition.

“Low gloss” surfaces give products a much sought-after aesthetic effect, especially in the wood-furniture, flooring and wall covering industry, because they can create a very natural appearance that contribute to giving greater emphasis to the materiality of the article. At present, the creation of matte surfaces frequently involves the use of coating products the formulation of which contains matting agents made from organic and/or inorganic substances which, by positioning themselves on the coated surface and/or emerging on it, are able to act on the degree of reflection of light, giving the observer the visual sensation of a low gloss surface. However, the use of matting agents produces a worsening of the surface performance of the coating since, not being involved in the cross-linking and polymerization process, they lead to a significant reduction of resistance to chemical agents. Moreover, the incorporation of these matting agents in the formulation of the coating product significantly influences the rheology modifying the viscosity thereof to the point that it is impossible to use high concentrations of such matting agents without negatively altering the “application” characteristics of the coating product.

A particular category of surface coatings is that of radiation-curable coating compositions polymerizable by e-beam or by ultraviolet radiation (UV). In general the cross-linking mechanism involves the use of actinic sources or ultraviolet radiation lamps (UV). UV lamp-induced cross-linking surface coatings may contain solvents, water and other coalescing substances in their formulation, or be characterized by a 100% solids content when their viscosity is adjusted by the addition of reactive diluents. The absence of volatile compounds such as water or volatile organic solvents results in that the applied coating thickness of coating systems having a 100% solids content only slightly reduces during the curing process. This slight shrinkage makes it more difficult to produce low gloss surfaces by the addition of conventional matting agents to the coating formulation. The Excimer lamp technology for pretreating radiation-curable coating formulations with high-energy radiation in the wavelength of ≤220 nm under inert gas to produce low gloss or even matte coatings is also known, as described in for example US-A-2019077138. The effect achieved by this pre-treatment with short-wave UV light is a photochemically induced micro-folding of the coating. This micro-folding is responsible for a low gloss or even matte surface. Full curing of the coating composition below the folded surface then takes place with conventional UV emitters such as for example mercury medium-pressure emitters or electron beam emitters. It has however been found that the chemical resistances, in particular the iodine stain resistance, of the low gloss coating is often not sufficiently high and/or the visual appearance of the coating is insufficient. Products containing iodine are widely used in hospitals, clinics, nursing homes and other health care facilities. These products can quickly reduce microbial populations on skin, gums, and other tissues or surfaces. Unfortunately, when iodine containing products are spilled or otherwise unintentionally contact surfaces such as floors or walls, they can cause semi-permanent dark yellow or brown stains. These stains can be very difficult to remove using traditional cleaning techniques, and are especially difficult to remove from floors and walls. Removal of such stains may require recoating the floor/wall or even replacing the floor. This can require substantial time and expenditure. It has furthermore been found that applying Excimer curing on radiation-curable epoxy acrylate coating composition which are known to have good iodine stain resistance does not result in coatings which are low gloss or matte or results in coatings with insufficient visual appearance.

The object of the present invention is to provide a method for producing a low gloss or even matte coating from a radiation-curable coating composition with improved or at least good iodine stain resistance levels.

According to the invention there is provided a process for producing a coating, wherein the process comprises
(1) Irradiating a radiation-curable coating composition with UV light having a wavelength ≤220 nm under inert gas, followed by
(2) Irradiating with UV light having a wavelength ≥300 nm or with E-beam,

wherein the radiation-curable coating composition comprises
(A) One or more oligomeric urethane acrylates (A) with a molar mass of from 1100 to 5000 g/mol and with an acrylate functionality of from 4 to 14, and
(B) One or more acrylate diluents (B) with a molar mass less than 650 g/mol and with an acrylate functionality of from 2 to 4, and

wherein

the amount of (A) is from 20 to 75 wt. % and the amount of (B) is from 25 to 80 wt. %, based on the total amount of (A) and (B), and

the total amount of (A) and (B) is at least 50 wt. % by weight of the radiation-curable coating composition.

It has surprisingly been found that the process of the invention is able to provide a low gloss or even matte coating with improved or even excellent iodine stain resistances. An additional advantage of the process of the invention is that the low gloss/matt coating also have improved or at least good mustard stain resistance. An additional advantage of the present invention is that the matte coating further has at least good visual appearance, which is expressed by a homogeneous surface appearance with few or no visual defects. With the process of the invention, low gloss or even matte coatings with a reduced or substantial absence of visual defects can be obtained. A further advantage of the present invention is that with the coating composition as claimed a low gloss or even matte coating with at least good iodine stain resistance properties can be obtained in only 2 irradiation steps (i.e. step (1) and (2)), in particular for coatings with a wet thickness (before curing) of at most 150 micron, more in particular of at most 120 micron, more in particular of at most 100 micron and more in particular of at most 50 micron.

In particular it has surprisingly been found that when applying a radiation-curable coating composition as claimed in a method for producing low gloss or matte coatings which method includes the pre-treatment of the coating composition with UV light with a wavelength ≤220 nm (further also referred to as the excimer radiation step), a low gloss or even matte coating with improved or even excellent iodine stain resistances can be obtained.

More in particular with the process of the invention a coating can be obtained with a gloss measured at 60° geometry of angle lower than 30 gloss units and a gloss measured at 85° geometry of angle lower than 50 gloss units (further referred to as low gloss) and with at least good visual appearance, while the visual assessed iodine stain resistance is at least 3, preferably 4 or 5 and/or the iodine stain resistance assessed by colorimetry (Δb-value) is lower than 33, preferably lower than 30. As used herein, the gloss is measured according to ISO2813 in the direction of the drawdown. The iodine stain resistance is measured according to EN12720: 2009 employing Gram's microscopy staining kit as iodine solution with a spot exposure time of 1 hour and rated after 24 hours. For the visual assessed iodine stain resistance, a score of from 1 to 5 is given according to the descriptive numerical rating code of EN12720: 2009, whereby a rating of 5 is the best and a rating of 1 is the worst. For the iodine stain resistance determined colorimetric, a Datacolor CHECK III from DATACOLOR Inc with b-value measurements according to ISO 7724; Δb-value=b_{(after 1 hr iodine exposure and rated after 24 hours)}−b_{(before exposure)}. More preferably, the coating obtained with the process of the invention has a gloss measured at 60° geometry of angle lower than 10 gloss units and a gloss measured at 85° geometry of angle lower than 15 gloss units (further referred to as matte) and at least good visual appearance, while the visual assessed iodine stain resistance is at least 3, preferably 4 or 5 and/or the iodine stain resistance assessed by colorimetry is lower than 33, preferably lower than 30. Even more preferably, the gloss measured at 60° geometry of angle is lower than 5 gloss units and the gloss measured at 85° geometry of angle is lower than 10 gloss units. US-A-2019077138 disclose to use epoxy acrylates or urethane acrylates as lacquer. It has been found that applying Excimer curing on radiation-curable epoxy acrylate coating composition which are known to have good iodine stain resistance does not result in coatings which are low gloss or matte or results in coatings with insufficient visual appearance. It has furthermore also been found that the urethane acrylate mixture disclosed in US 20190077138 in paragraph [0046] in column 4 results in a coating with very poor iodine resistance The urethane acrylates of this mixture are different from the urethane acrylates (A) used in the present invention.

It has furthermore surprisingly been found that that with the coating composition as claimed a low gloss or even matte coating with an at least good visual appearance can be obtained in only 2 irradiation steps (i.e. step (1) and (2)), in particular for coatings with a wet thickness (before curing) of at most 150 micron, more in particular of at most 120 micron, more in particular of at most 100 micron and more in particular of at most 50 micron. US-A-2014371384 teaches that an additional partial gelation irradiation step is needed prior to the excimer radiation step (step (1) of the process of the present invention) and the finish curing step (step (2) of the process of the present invention) and thus US-A-2014371384 teaches that three irradiation steps are needed to obtain a low gloss/matte coating with a homogeneous surface structure, see in particular Table 2.

As used herein, the acrylate functionality of a compound is the number of acrylate functional groups per mole of molecule of the compound. As used herein, the average acrylate

$$functionality = \overline{f} = \frac{{\sum }_{k} \frac{{w}_{k}}{{M}_{k}} {f}_{k}}{{\sum }_{k} \frac{{w}_{k}}{{M}_{k}}} ,$$

in which wₖ is the amount of compound in gram present in the radiation-curable coating composition with a specific molar mass Mₖ and with a specific acrylate functionality fₖ

An acrylate functional group has the following formula:

CH₂═CH—C(O)O—

The molar mass of a compound is the calculated molar mass obtained by adding the atomic masses of all atoms present in the structural formula of a compound.

The radiation-curable coating composition used in the process of the present invention comprises one or more oligomeric urethane acrylates (A) with a molar mass of from 1100 to 5000 g/mol and with an acrylate functionality of from 4 to 14 in amount of from 20 to 75 wt. %, based on the total amount of (A) and (B).

Said one or more oligomeric urethane acrylates (A) have a molar mass of at least 1100 g/mol, preferably of at least 1200 g/mol, more preferably of at least 1300 g/mol. Said one or more oligomeric urethane acrylates (A) have a molar mass of at most 5000 g/mol, preferably of at most 4000 g/mol, more preferably of at most 3000 g/mol.

Said one or more oligomeric urethane acrylates (A) have an acrylate functionality of at least 4, preferably of at least 5, more preferably of at least 6. Said one or more oligomeric urethane acrylates (A) have an acrylate functionality of at most 14, preferably of at most 12, more preferably of at most 10.

Said one or more oligomeric urethane acrylates (A) are present in the radiation-curable coating composition in an amount of from 20 to 75 wt. %, based on the total amount of (A) and (B). Preferably, the amount of the one or more oligomeric urethane acrylates (A) in the radiation-curable coating composition is in the range from 25 to 73 wt. %, more preferably from 30 to 70 wt. %, even more preferably from 30 to 65 wt. %, even more preferably from 30 to 60 wt. %, relative to the total amount of (A) and (B).

The radiation-curable coating composition used in the process of the present invention may also comprise oligomeric urethane acrylates with a molar mass as defined for the (A) compounds present in the radiation-curable coating composition (i.e. from 1100 to 5000 g/mol, preferably of at least 1200 g/mol, more preferably of at least 1300 g/mol and preferably at most 4000 g/mol, more preferably of at most 3000 g/mol) but with a different acrylate functionality than defined for (A). Such oligomeric urethane acrylates are preferably present in the radiation-curable coating composition in such an amount that the average acrylate functionality of the urethane acrylate oligomers with a molar mass as defined for (A) is in the range of preferably from 3.5 to 14, more preferably from 5 to 12 and most preferably from 6 to 10. As used herein, the average acrylate functionality of the urethane acrylate oligomers with a molar mass as defined for

$$( A ) = \overline{f} = \frac{{\sum }_{k} \frac{{w}_{k}}{{M}_{k}} {f}_{k}}{{\sum }_{k} \frac{{w}_{k}}{{M}_{k}}} ,$$

in which wₖ is the amount of urethane acrylate oligomers in g present in the radiation curable coating composition with a specific molar mass Mₖ as defined for (A) and with a specific acrylate functionality fₖ which can be as defined for (A) or lower or higher than as defined for (A).

The radiation-curable coating composition used in the process of the present invention comprises one or more acrylate diluents (B) with a molar mass less than 650 g/mol and with an acrylate functionality of from 2 to 4 in an amount of from 25 to 80 wt. %, based on the total amount of (A) and (B).

Said one or more acrylate diluents (B) have a molar mass less than 650 g/mol, preferably a molar mass of at most 500 g/mol, more preferably of at most 450 g/mol. Said one or more acrylate diluents (B) preferably have a molar mass of at least 125 g/mol, preferably of at least 150 g/mol, more preferably of at least 175 g/mol and even more preferably of at least 200 g/mol.

Said one or more acrylate diluents (B) have an acrylate functionality of from 2 to 4, preferably said one or more acrylate diluents (B) have an acrylate functionality of 2 or 3.

Said one or more acrylate diluents (B) are present in the radiation-curable coating composition in an amount of from 25 to 80 wt. %, based on the total amount of (A) and (B). Preferably, the amount of the one or more acrylate diluents (B) in the radiation-curable coating composition is in the range from 27 to 75 wt. %, more preferably from 30 to 70 wt. %, more preferably from 35 to 70 wt. %, more preferably from 40 to 70 wt. %, relative to the total amount of (A) and (B).

The radiation-curable coating composition used in the process of the present invention may also comprise acrylate diluents with a molar mass as defined for the (B) compounds present in the radiation-curable coating composition (i.e. lower than 650 g/mol, preferably of at most 500 g/mol, more preferably of at most 450 g/mol and preferably of at least 125 g/mol, more preferably of at least 150 g/mol, more preferably of at least 175 g/mol, even more preferably of at least 200 g/mol) but with a different acrylate functionality than defined for (B), for example with an acrylate functionality of 1, 5, 6 or 7. Such acrylate diluents are preferably present in the radiation-curable coating composition in such an amount that the average acrylate functionality of the acrylate diluents with a molar mass as defined for (B) is in the range of preferably from 1.9 to 5.3, more preferably from 2 to 4. Even more preferably the average acrylate functionality of the acrylate diluents with a molar mass as defined for (B) is in the range from 2 to 3, as this advantageously may result in a more pronounced matting effect. As used herein, the average acrylate functionality of the acrylate diluents with a molar mass as defined for

$$( B ) = \overline{f} = \frac{{\sum }_{k} \frac{{w}_{k}}{{M}_{k}} {f}_{k}}{{\sum }_{k} \frac{{w}_{k}}{{M}_{k}}} ,$$

in which wₖ is the amount of acrylate diluents in g present in the radiation curable coating composition with a specific molar mass Mₖ as defined for (B) and with a specific acrylate functionality fₖ which can be as defined for (B) or lower or higher than as defined for (B).

In an embodiment of the invention, the molar mass of the acrylate diluent(s) is the calculated molar mass obtained by adding the atomic masses of all atoms present in the structural formula of the acrylate diluent and the molar mass of the oligomeric urethane acrylate(s) (A) is the number average molecular weight determined using Triple Detection Size Exclusion Chromatography with tetrahydrofuran THF as eluent.

The total amount of (A) and (B) in the radiation-curable coating composition used in the process of the present invention is at least 50 wt. %, preferably at least 55 wt. %, more preferably at least 60 wt. %, more preferably at least 65 wt. %, even more preferably at least 70 wt. % and most preferably at least 75 wt. %, by weight of the radiation-curable coating composition. The higher the total amount of (A) and (B) in the radiation-curable coating composition used in the process of the present invention, the higher the iodine stain resistance of the coating obtained with the process of the present invention.

Preferably, said one or more oligomeric urethane acrylates (A) have an acrylate functionality per molar mass (f/M, mol “C═C”/kg) higher than 2.4 mol/kg and less than 5.5 mol/kg. More preferably said one or more oligomeric urethane acrylates (A) have an acrylate functionality per molar mass (f/M, mol “C═C”/kg) higher than 3 mol/kg and less than 5 mol/kg.

Said one or more oligomeric urethane acrylates (A) is preferably the reaction product of at least
i) at least one organic polyisocyanate,
ii) at least one organic isocyanate-reactive polyol,
iii) a hydroxyl group containing acrylate compound

The polyisocyanate compound i) used to prepare the urethane acrylate is preferably a diisocyanate compound. Preferably, the diisocyanate compound comprises, consists essentially of, or consists of isophorone diisocyanate, 2,4-toluene diisocyanate, 2,6-toluene diisocyanate, 2,4- and/or 4,4′-methylenedicyclohexyl diisocyanate, methylenediphenyl diisocyanate , tetramethylxylene diisocyanate, (hydrogenated) xylylene diisocyanate, 1,5-pentane diisocyanate, 2,2,4-trimethyl-hexamethylene diisocyanate, 2,4,4-trimethyl-hexamethylene diisocyanate, or hexamethylene diisocyanate, or mixtures thereof.

Examples of suitable polyol compounds ii) to prepare the urethane acrylate include polyether polyols, polyester polyols, polycarbonate polyols, polycaprolactone polyols, acrylic polyols, and other polyols. These polyols may be used either individually or in combinations of two or more.

The hydroxyl-group containing acrylate compound iii) used to prepare the urethane acrylate are for example pentaerythritol triacrylate, dipentaerythritol pentaacrylate, trimethylolpropane diacrylate, glyceroldiacrylate, and ethoxylated and/or propoxylated versions of these compounds and any mixture thereof.

Said one or more acrylate diluents (B) is preferably selected from the group consisting of trimethylolpropane diacrylate, trimethylolpropane triacrylate, pentaerythritol triacrylate, pentaerythritol tetraacrylate1,6-hexane diol diacrylate, neopentyl glycol diacrylate, diethylene glycol diacrylate, dipropylene glycol diacrylate, glycerol propoxylate triacrylate, ethoxylated trimethylolpropane triacrylate, triethylene glycol diacrylate, tripropylene glycol diacrylate, ditrimethylolpropane tetraacrylate, and any mixture thereof.

The radiation-curable coating composition used in the process of the present invention is preferably 100% radiation-curable. A 100% radiation-curable coating composition refers to a coating composition which is substantially free of water and non-polymerizable volatile compounds. As used herein, substantially free of water and non-polymerizable volatile compounds means that the composition contains less than 20 wt. %, preferably less than 10 wt. % more preferably less than 5 wt. %, more preferably less than 3 wt. %, more preferably less than 1 wt. % of water and non-polymerizable volatile compounds by weight of the radiation-curable coating composition of the present invention. A non-polymerizable volatile compound is a compound having an initial boiling point less than or equal to 250° C. measured at a standard atmospheric pressure of 101.3 kPa.

The process of the present invention comprises
(1) Irradiating a radiation-curable coating composition with UV light having a wavelength ≤220 nm under inert gas, preferably with a wavelength ≥120 nm is applied, more preferably ≥150 nm, particularly preferably 172 nm or 195 nm, causing micro-folding followed by
(2) Irradiating with UV light having a wavelength ≥300 nm or with E-beam.

Suitable radiation sources for step (1) are excimer UV lamps, which emit UV light with a wavelength ≤220 nm and preferably with a wavelength ≥120 nm, more preferably ≥150 nm, particularly preferably 172 nm or 195 nm. The radiation dose used in step (1) is usually in the range from 0.1 to 150 mJ/cm², preferably in the range of from 1 to 100 mJ/cm², more preferably from 1 to 20 mJ/cm², more preferably from 2 to 15 mJ/cm². Step (1) must be performed in an inert gas atmosphere. An inert gas atmosphere is understood to mean an essentially oxygen-free atmosphere, i.e. an atmosphere which contains less than 0.5 percent by volume of oxygen, preferably less than 0.1 percent by volume of oxygen and especially preferably less than 0.05 percent by volume of oxygen. As a rule, an inert gas atmosphere is achieved by flushing the area which is exposed to the UV radiation with a stream of inert gas. The inert gas atmosphere prevents undesired ozone formation on the one hand and prevents the polymerization of the lacquer layer from being inhibited on the other hand.

Examples of inert gases are nitrogen, carbon dioxide, combustion gases, helium, neon or argon. Nitrogen is particularly preferably used. This nitrogen should only contain very small amounts of foreign gases such as oxygen, preferably with a purity grade of <300 ppm oxygen.

In step (2) of the process of the present invention, the coating layer obtained in step (1) is irradiated with UV light having a wavelength (higher than or equal to) 300 nm or with E-beam to achieve that the radiation-curable compounds of the coating composition largely or preferably completely polymerizes, so that the coating layer is preferably fully cured. In case E-beam irradiation (150 to 300 kV) is applied in step (2), usually a dose of 10 to 100 kGy, preferably 20 to 50 kGy, is applied. In step (2) UV irradiation is preferred, preferably with a wavelength of from 300 to 420 nm and preferably with a radiation dose of from 100 to 4000 mJ/cm², more preferably from 150 to 2500 mJ/cm². High- and medium-pressure mercury vapour lamps can in particular be used as UV radiation sources, wherein the mercury vapour can be doped with further elements such as gallium or iron. Step (2) can optionally also be performed in an inert gas atmosphere. In case UV irradiation is applied in step (2), the radiation-curable coating composition comprises a photo-initiator. If the radiation curable coating composition of the invention comprise one or more photo-initiators, they are included in an amount sufficient to obtain the desired cure response. Typically, the one or more photo-initiators are included in amounts in a range of from 0.1 to 10% by weight of the coating composition. Preferably, the one or more photo-initiators are present in an amount, relative to the entire weight of the coating composition, of from 0.25 wt. % to 10 wt. %, more preferably from 0.5 wt. % to 8 wt. % and even more preferably from 1 wt. % to 5 wt. %. A photoinitiator is a compound that chemically changes due to the action of light or the synergy between the action of light and the electronic excitation of a sensitizing dye to produce at least one of a radical, an acid, and a base. Well-known types of photoinitiators include cationic photoinitiators and free-radical photoinitiators. According to an embodiment of the present invention, the photoinitiator is a free-radical photoinitiator.

In an embodiment, the photoinitiator compound includes, consists of, or consists essentially of one or more acylphosphine oxide photoinitiators. Acylphosphine oxide photoinitiators are known, and are disclosed in, for example, U.S. Pat. Nos. 4,324,744, 4,737,593, 5,942,290, 5,534,559, 6,020,529, 6,486,228, and 6,486,226. Preferred types of acylphosphine oxide photoinitiators for use in the photoinitiator compound include bisacylphosphine oxides (BAPO) or monoacylphosphine oxides (MAPO). More specifically, examples include 2,4,6-trimethylbenzoylethoxyphenylphosphine oxide (CAS #84434-11-7) or 2,4,6-trimethylbenzoyldiphenylphosphine oxide (CAS #127090-72-6).

In a preferred embodiment, the photoinitiator compound may also optionally comprise, consist of, or consist essentially of α-hydroxy ketone photoinitiators. For instance, suitable α-hydroxy ketone photoinitiators are α-hydroxycyclohexyl phenyl ketone, 2-hydroxy-2-methyl-1-phenylpropanone, 2-hydroxy-2-methyl-1-(4-isopropylphenyl)propanone, 2-hydroxy-2-methyl-1-(4-dodecylphenyl)propanone, 2-Hydroxy-1-{4-[4-(2-hydroxy-2-methyl-propionyl)-benzyl]-phenyl}-2-methyl-propan-1-one and 2-hydroxy-2-methyl-1-[(2-hydroxyethoxy)phenyl]propanone.

In another embodiment, the photoinitiator compound includes, consists of, or consists essentially of: α-aminoketones, such as 2-methyl-1-[4-(methylthio)phenyl]-2-(4-morpholinyl)-1-propanone, 2-benzyl-2-(dimethylamino)-1-[4-(4-morpholinyl)phenyl]-1-butanone, 2-(4-methylbenzyl-2-(dimethylamino)-1-[4-(4-morpholinyl)phenyl]-1-butanone or 2-benzyl-2-(dimethylamino)-1-[3,4-dimethoxyphenyl]-1-butanone; benzophenones, such as benzophenone, 2,4,6-trimethylbenzophenone, 4-methylbenzophenone, 2-methylbenzophenone, 2-methoxycarbonylbenzophenone, 4,4′-bis(chloromethyl)-benzophenone, 4-chlorobenzophenone, 4-phenylbenzophenone, 4,4′-bis(dimethylamino)-benzophenone, 4,4′-bis(diethylamino)benzophenone, methyl2-benzoylbenzoate, 3,3′-dimethyl-4- methoxybenzophenone, 4-(4-methylphenylthio)benzophenone, 2,4,6-trimethyl-4′-phenyl-benzophenone or 3-methyl-4′-phenyl-benzophenone; ketal compounds, for example 2,2-dimethoxy-1,2-diphenyl-ethanone; and monomeric or dimeric phenylglyoxylic acid esters, such as methylphenylglyoxylic acid ester, 5,5′-oxo-di(ethyleneoxydicarbonylphenyl) or 1,2-(benzoylcarboxy)ethane.

Yet further suitable photoinitiators for use in the photoinitiator compound include oxime esters, such as those disclosed in U.S. Pat. No. 6,596,445. Still another class of suitable photoinitiators for use in the photoinitiator compound include, for example, phenyl glyoxalates, for example those disclosed in U.S. Pat. No. 6,048,660.

In another embodiment, the photoinitiator compound may comprise, consist of, or consist essentially of one or more alkyl-, aryl-, or acyl-substituted compounds not mentioned above herein.

According to another embodiment, the composition may contain a photoinitiator that is an alkyl-, aryl-, or acyl-substituted compound. In an embodiment the alkyl-, aryl-, or acyl-substituted photoinitiator possesses or is centered around an atom in the Carbon (Group 14) group. In such instance, upon excitation (via absorption of radiation) the Group 14 atom present in the photoinitiator compound forms a radical. Such compound may therefore produce a radical possessing or centered upon an atom selected from the group consisting of silicon, germanium, tin, and lead. In an embodiment, the alkyl-, aryl-, or acyl-substituted photoinitiator is an acylgermanium compound. Such photoinitiators are described in, U.S. Pat. No. 9,708,442, assigned to DSM IP Assets B.V. Known specific acylgermanium photoinitiators include benzoyl trimethyl germane (BTG), tetracylgermanium, or bis acyl germanoyl (commercially available as Ivocerin® from Ivoclar Vivadent AG, 9494 Schaan/Liechtenstein).

Photoinitiators according to the present invention may be employed singularly or in combination of one or more as a blend. Suitable photoinitiator blends are for example disclosed in U.S. Pat. No. 6,020,528 and U.S. Pat. app. No. 60/498,848. According to an embodiment, the photoinitiator compound includes a photoinitiator blend of, for example, bis(2,4,6-trimethylbenzoyl) phenyl phosphine oxide (CAS #162881-26-7) and 2,4,6,-trimethylbenzoylethoxyphenylphosphine oxide (CAS #84434-11-7) in ratios by weight of about 1:11, 1:10, 1:9, 1:8 or 1:7.

Another especially suitable photoinitiator blend is a mixture of bis(2,4,6-trimethylbenzoyl)phenyl phosphine oxide, 2,4,6,-trimethylbenzoylethoxyphenylphosphine oxide and 2-hydroxy-2-methyl-1-phenyl-1-propanone (CAS #7473-98-5) in weight ratios of for instance about 3:1:15 or 3:1:16 or 4:1:15 or 4:1:16. Another suitable photoinitiator blend is a mixture of bis(2,4,6-trimethylbenzoyl)phenyl phosphine oxide and 2-hydroxy-2-methyl-1-phenyl-1-propanone in weight ratios of for instance about 1:3, 1:4 or 1:5.

One or more of the aforementioned photoinitiators can be employed for use in the photoinitiator compound in compositions according to the present invention in any suitable amount and may be chosen singly or in combination of one or more of the types enumerated herein. In a preferred embodiment, the photoinitiator compound comprises, consists of, or consists essentially of free-radical photoinitiators. In an embodiment, the photoinitiator compound is present in an amount, relative to the entire weight of the composition, of from about 0.1 wt. % to about 10 wt. %, or from about 0.1 wt. % to about 5 wt. %, or from about 1 wt. % to about 5 wt. %.

The coating composition usually further contain an additive compound; that is, a collection of one or more than one individual additives having one or more than one specified structure or type. Suitable additives are for example light stabilizers, such as UV absorbers and reversible free-radical scavengers (HALS), photosensitizers, antioxidants, degassing agents, wetting agents, emulsifiers, slip additives, waxes, polymerisation inhibitors, adhesion promoters, flow control agents, film-forming agents, rheological aids such as thickeners, flame retardants, corrosion inhibitors, waxes, driers and biocides. One or more of the aforementioned additives can be employed in the coating composition used in the process of the present invention in any suitable amount and may be chosen singly or in combination of one or more of the types enumerated herein. In a preferred embodiment, the additive compound is present in an amount, relative to the entire weight of the coating composition, of from about 0 wt. % to 40 wt. %, or from 0 wt. % to 30 wt. %, or from 0 wt. % to 20 wt. %, or from 0 wt. % to 10 wt. %, or from 0 wt. % to 5 wt. %; or from 0.01 wt. % to 40 wt. %; or from 0.01 wt. % to 30 wt. %, or from 0.01 wt. % to 20 wt. %, or from 0.01 wt. % to 10 wt. %, or from 0.01 wt. % to 5 wt. %, or from 0.1 wt. % to 2 wt. %. According to another embodiment, the additive compound is present, relative to the weight of the entire radiation curable composition, from 1 wt. % to 40 wt. %, or from 1 wt. % to 30 wt. %, or from 1 wt. % to 20 wt. %, or from 1 wt. % to 10 wt. %, or from 1 wt. % to 5 wt. %.The coating composition can also be pigmented. The coating composition then contain at least one pigment. Preferably the coating composition does not contain any pigments. The coating composition can also contain one or more inorganic fillers.

The coating composition can also contain one or more solvents. Suitable solvents are inert in respect of the functional groups present in the coating composition, from the time at which they are added to the end of the process. Examples of suitable solvents are hydrocarbons, alcohols, ketones and esters, for example toluene, xylene, isooctane, acetone, butanone, methyl isobutyl ketone, ethyl acetate, butyl acetate, tetrahydrofuran, dimethyl acetamide, dimethyl formamide. The coating composition preferably is a 100% radiation-curable coating composition as defined herein above.

The coating composition can also contain matting agents which have an additional matting effect. Suitable matting agents are for example silicon dioxides. The amount of matting agents, if included, is typical in the range of from 0.1 to 10 wt. %, in particular in the range of from 0.5 to 5 wt. %, based on the total weight of the radiation-curable compounds in the coating composition.

The process of the present invention optionally includes an additional radiation curing step prior to the excimer radiation step, i.e. prior to the step of irradiating by UV light with a wavelength ≤220 nm under inert gas. In this additional radiation curing step irradiation is preferably effected with UV light having a wavelength of from 300 nm to 450 nm with a radiation dose which results in partial curing of the coating composition. Accordingly, the process of the invention for producing a coating from a radiation-curable coating composition comprises the following steps:
(1a) Providing an uncured layer of a radiation-curable coating composition as defined herein above on a surface of a substrate,
(1b) Optionally irradiating the uncured layer from step (1) with UV light having a wavelength of from 300 to 450 nm, preferably from 300 to 420 nm with a radiation dose which results in partial curing of the layer, preferably with a radiation dose from 20 to 200 mJ/cm², more preferably with a radiation dose from 30 to 100 mJ/cm²,
(1) Irradiating the uncured layer from step (1a) or the partially cured layer from step (1b) with UV light having a wavelength of (lower than or equal to) 220 nm under inert gas, and
(2) Irradiating the coating layer from step (1) with UV light having a wavelength (higher than or equal to) 300 nm or with E-beam.

In step (1a) the radiation-curable coating composition is applied to a substrate by methods known to the person skilled in the art, such as for example knife coating, brushing, roller coating. The coating composition is applied to the substrate in a coating thickness (before curing) of preferably from 3 to 150 micron, more preferably from 3 to 120 micron, more preferably from 3 to 100 micron, more preferably from 3 to 50 micron, even more preferably from 3 to 30 micron and even more preferably from 5 to 30 micron. In a preferred embodiment of the invention, the curing of the radiation-curable coating composition is effected in only 2 irradiation steps (i.e. step (1) and (2)). In this preferred embodiment, the radiation-curable coating composition is applied to the substrate in a coating thickness (before curing) of of at most 150 micron, more in particular of at most 120 micron, more in particular of at most 100 micron and more in particular of at most 50 micron.

In optional step (1b) some of the reactive ethylenically unsaturated double bonds of the curable compounds polymerize in the uncured coating layer, so that the coating layer partially cures but is not yet fully cured. This process is also known as pre-curing. The irradiating in step (1b) preferably takes place under atmospheric conditions, in other words not under inert gas conditions and/or not in an oxygen-reduced atmosphere. UV-A-emitting radiation sources (e.g. fluorescent tubes, LED lamps), high- or medium-pressure mercury vapour lamps, wherein the mercury vapour can be modified by doping with other elements such as gallium or iron, pulsed lamps (known as UV flash lamps) or halogen lamps are suitable as radiation sources for UV light in the specified wavelength range in step (1b). In a preferred embodiment of the invention, the process is performed without step (1b).

Suitable substrates for the process according to the invention are for example mineral substrates such as fiber cement board, wood, wood containing materials, paper including cardboard, textile, leather, metal, thermoplastic polymer, thermosets, ceramic, glass. Suitable thermoplastic polymers are for example polyvinylchloride PVC, polymethylmethacrylate PMMA, acrylonitrile-butadiene-styrene ABS, polycarbonate, polypropylene PP, polyethylene PE, polyamide PA and polystyrene. Suitable thermosets are for example linoleum, epoxy, melamine, novolac, polyesters and urea-formaldehyde. Preferred substrates are flat (i.e. not containing sharp edges or angles <150° in the surface to be coated) and non-porous substrate (i.e. not so porous that the coating composition when it is applied would essentially only penetrate into the substrate). The substrate is optionally pre-treated and/or optionally pre-coated. For example, thermoplastic plastic films can be treated with corona discharges before application or pre-coated with a primer. Mineral building materials are also usually provided with a primer before the coating composition is applied.

The coating obtained in the process of the invention can advantageously be used in a floor or wall covering or in automotive interior or on furniture, on window frames or on façade panels.

The present invention further relates to the radiation-curable coating composition as described herein above. The present invention further relates to a coated substrate that is obtained by coating a substrate, preferably a plastic, paper or metal substrate or a substrate of a combination of any of plastic, paper and metal with the process as described herein above.

The present invention is now illustrated by reference to the following examples. Unless otherwise specified, all parts, percentages and ratios are on a weight basis.

Table 1 describes the various components used for preparing the compositions used in the present examples. Table 2 describes the relative amounts of the reagents described in Table 1 which were used to synthesize the oligomers used in the present examples. Table 3 describes the relative amounts of the ingredients described in Table 1 and Table 2 which was used to prepare the example formulations.

TABLE 1
Materials used

| | | Supplier/ |
|---|---|---|
| Compo- | | Manufac- |
| nent | Chemical Descriptor | turer |
| PTHF650 | Bifunctional polytetrahydrofuran; molar | Mitsubishi |
| | mass 650; CAS 25190-06-1 | |
| PPG4000 | Bifunctional polypropylene glycol; molar | Wanhua |
| | mass 4000; CAS 25322-69-4 | |
| HBP500 | Boltorn ™ P-500; Hyperbranched | Perstorp |
| | polyester polyol; molar mass 1800 | |
| TDI | Toluene diisocyanate; CAS 26471-62-5 | Covestro, |
| | | BASF |
| IPDI | Isophorone diisocyanate; CAS 4098-71-9 | Evonik |
| HEA | 2-Hydroxyethyl acrylate; CAS 818-61-1 | Nippon |
| | | Shokubai |
| eTMPDA | Ethoxylated (EO9) trimethylolpropane | DSM |
| | diacrylate; CAS 37314-71-9 | |
| PET3A | Pentaerythritol triacrylate; CAS 3524-68-3 | DSM |
| | diluted with 34 wt % pentaerythritol | |
| | tetraacrylate | |
| DP5A | Dipentaerythritol penta acrylate; CAS | DSM |
| | 6056-81-2 diluted with 58 wt % | |
| | dipentaerythritol hexaacrylate | |
| NeoRad ™ | A trifunctional urethane acrylate with | DSM |
| U-6288 | a molar mass of 900 diluted with monomer | |
| Ebecryl ® | A hexafunctional urethane acrylate with | Allnex |
| 5129 | a molar mass of 800 | |
| BHT | Butylated hydroxytoluene (food grade); CAS | Lanxess, |
| | 128-37-0 | BASF |
| DBTDL | Dibutyltin dilaurate; CAS 77-58-7 | Evonik |
| LA | Lauryl acrylate; CAS 2156-97-0 | DSM |
| DPGDA | Dipropylene glycol diacrylate; CAS | DSM |
| | 57472-68-1 | |
| TMPTA | Trimethylolpropane triacrylate; CAS | DSM |
| | 15625-89-5 | |
| Di-TMPTA | Ditrimethylolpropane tetraacrylate; CAS | DSM |
| | 94108-97-1 | |
| DPHA | Dipentaerythritol hexaacrylate; CAS | Sigma- |
| | 29570-58-9 | Aldrich |
| PI | 2-Hydroxy-2-methylpropiophenone; CAS | IGM Resins |
| | 7473-98-5 | |
| EA | Agisyn ™ 9760: epoxy acrylate diluted | DSM |
| | with 50% trimethylolpropane triacrylate | |
| PA | AgiSyn ™ 720: polyester acrylate | DSM |

Preparation of the Urethane Acrylate Oligomers UA-I and UA-II and Comparative UA-A to UA-E

Urethane acrylate oligomers used herein were prepared using the molar amounts specified in table 2. After charging the diisocyanate, the catalyst (DBTDL), and the stabilizer (BHT) into the reactor, the hydroxy-functional compounds were added sequentially after completion of the previous urethane reaction.

Due to the high viscosity, urethane acrylate oligomer E has been produced with DPGDA as reactive diluent by charging first 20 wt. % DPGDA in the reactor followed by the components (80 wt. %) which are added with the sequence mentioned above and in amounts specified in Table 2.

TABLE 2
Composition urethane acrylate oligomers

| | | | | | | Calculated |
|---|---|---|---|---|---|---|
| | | | | | | molar |
| | | | | | | mass |
| Example | Diisocyanate | Polyol | Endcap | Ideal structure | Functionality | (g/mol)* |
| UA-I | 2 mol IPDI | 1 mol | 2 mol | pentaerythritol | 6 | 1690 |
| | | PTHF650 | pentaerythritol | triacrylate - | | |
| | | | triacrylate | IPDI-PTHF650- | | |
| | | | | IPDI- | | |
| | | | | pentaerythritol | | |
| | | | | triacrylate | | |
| UA-II | 2 mol IPDI | 1 mol | 2 mol | dipentaerythritol | 10 | 2142 |
| | | PTHF650 | dipentaerythritol | pentaacrylate - | | |
| | | | pentaacrylate | IPDI-PTHF650- | | |
| | | | | IPDI- | | |
| | | | | dipentaerythritol | | |
| | | | | pentaacrylate | | |
| UA-A | 1 mol IPDI | — | 2 mol | pentaerythritol | 6 | 818 |
| | | | pentaerythritol | triacrylate - | | |
| | | | triacrylate | IPDI- | | |
| | | | | pentaerythritol | | |
| | | | | triacrylate | | |
| UA-B | 2 mol IPDI | 1 mol | 2 mol HEA | HEA-IPDI- | 2 | 1326 |
| | | PTHF650 | | PTHF650-IPDI- | | |
| | | | | HEA | | |
| UA-C | 3 mol TDI | 2 mol | 2 mol HEA | HEA-(TDI- | 2 | 8754 |
| | | PPG4000 | | PPG4000)₂- | | |
| | | | | TDI-HEA | | |
| UA-D | 3 mol TDI | 2 mol | 2 mol eTMPDA | eTMPDA-(TDI- | 4 | 9798 |
| | | PPG4000 | | PPG4000)₂- | | |
| | | | | TDI-eTMPDA | | |
| UA-E | 1 mol IPDI | 0.067 mol | 1 mol HEA | HBP500-(IPDI- | 15 | 6870 |
| | | HBP500 | | HEA)₁₅ | | |

*The molar mass of the oligomeric urethane acrylate (A) is the calculated molar mass obtained by adding the atomic masses of all atoms present in the structural formula of the oligomeric urethane acrylate (A). When the exact structural formula of a reactant used to prepare the oligomeric urethane acrylate (A) is not known, the molar mass of the reactant to be used in the calculation of the molar mass of the oligomeric urethane acrylate is the number average molecular weight determined using Triple Detection Size Exclusion Chromatography using tetrahydrofuran THF as eluent.

The viscosity of UA-I is 56 Pa·s at 60° C. and the viscosity of UA-II is 250 Pa·s at 25° C., measured on a Brookfield DV-III Ultra cone and plate rheometer equipped with a CP-52 spindle.

Preparation of Formulations

The ingredients listed in Table 3A-3D and 3F were added into a HDPP jar and mixed thoroughly using a speedmixer (DAC 150.1 FV, Hauschield GmbH) for 2 min @ 3500 rpm.

Application of Formulations

The formulations obtained were applied on a Leneta card (2C Leneta Inc) using a 24 μm wire rod applicator (#3 K bar, RK Printcoat Instruments Ltd) unless otherwise stated. For the other thicknesses, i.e. 6 μm, 12 μm, 50 μm respectively 100 μm , #1, 2, 5 respectively 8 K bar were applied.

Curing of the Formulations

Immediately (within 20 seconds) after application the formulations were cured on a UVio curing rig with a conveyor belt speed of 15 m/min equipped with 2 lamps. The first Lamp was a Excirad 172 lamp (IOT GmbH, xenon based excimer lamp generating 172 nm light) under which the cure was performed with a radiation dose of 6.9 mJ/cm² (determined with an ExciTrack172, IOT GmbH) in a nitrogen atmosphere (O2 level <50 ppm detected with IOT inline detector). The next cure step was performed by the second lamp being a Light Hamer 10 Mark II equipped with a H-bulb operating @ 100% power (Heraeus Holding, Hg doped UV lamp generating UV light with wave lengths ≥300 nm, 1 J/cm² total dose as determined with am Power Puck II (EIT Inc)) in air.

Testing of the Cured Formulations

The gloss is determined according to ISO2813 in the direction of the drawdown and is expressed in gloss units (GU).

The iodine resistance is determined according to EN12720:2009 employing Gram's microscopy staining kit as iodine solution with a spot exposure time of 1 hr and rated after 24 hrs according to the descriptive numerical rating code as described in EN12720: 2009 (rating 5 is the best, 1 is the worst).

Alternatively the iodine resistance was determined colorimetric using a Datacolor CHECK III from DATACOLOR Inc b-value measurements according to ISO 7724; Δb-value=b_{(after 1 hr iodine exposure and rated after 24 hours)}−b_{(before exposure)}. A higher Δb value indicates larger color change due to staining, therefore worse iodine stain resistance performance.

A coating with an at least good iodine stain resistance is a coating with an iodine stain resistance rating according to EN12720:2009 of 3, 4 or 5 and/or with an iodine stain resistance Δb-value assessed by colorimetry according to ISO 7724 of lower than 33.

The mustard stain resistance is measured according to EN12720: 2009 employing mild French mustard from Kühne as mustard stain with a spot exposure time of 24 hour and rated after 24 hours. For the visual assessed mustard stain resistance, a score of from 1 to 5 is given according to the descriptive numerical rating code of EN12720: 2009, whereby a rating of 5 is the best and a rating of 1 is the worst. An at least good mustard stain resistance means a rating of 3 , 4 or 5.

The visual appearance was rated from 1 to 5 where
5=Even, smooth and uniform surface appearance without any obvious deviations
4=Even and smooth surface with very few local defects such as glossy spots
3=Generally smooth surface with few local defects such as glossy spots and/or gloss deviations
2=Irregular surface with many local defects such as glossy spots and/or gloss deviations and/or wrinkle deviations
1=Highly irregular surface with defects such as gloss deviations and glossy spots and obvious wrinkle deviations

As used herein, a coating with an at least good visual appearance is a coating with a visual appearance with a rating of at least 3.

Calculation of Average Functionality of Acrylate Diluents

The average acrylate functionality of the acrylate diluents with a molar mass as defined for (B) (less than 650 g/mol) (further referred to as calculated average functionality of acrylate diluents) is calculated according to

$$\overline{f} = \frac{{\sum }_{k} \frac{{w}_{k}}{{M}_{k}} {f}_{k}}{{\sum }_{k} \frac{{w}_{k}}{{M}_{k}}} ,$$

in which wₖ is the amount of acrylate diluents in g present in the radiation curable coating composition with a specific molar mass Mₖ as defined for (B) and with a specific acrylate functionality fₖ which can be as defined for (B) or lower or higher than as defined for (B).

We illustrate this calculation with a theoretical example:

For a formulation consisting of 60 grams of urethane acrylate oligomer having molar mass >650 g/mol, 30 grams of DPGDA (having molar mass 242 g/mol and acrylate functionality of 2), 10 grams of Di-TMPTA (having molar mass 466 g/mol and acrylate functionality of 4), and 2.5 grams of photoinitiator: the summation over components k includes only DPGDA and Di-TMPTA and the calculated average functionality of acrylate diluents of this theoretical formulation is

$$\overline{f} = \frac{\frac{30 g}{242 \frac{g}{mol}} \times 2 + \frac{10 g}{466 \frac{g}{mol}} \times 4}{\frac{30 g}{242 \frac{g}{mol}} + \frac{10 g}{466 \frac{g}{mol}}} = 2.3 .$$

Since pentaerythritol triacrylate, CAS 3524-68-3, is diluted with 34 wt. % pentaerythritol tetraacrylate, UA-I contains 15% by mass pentaerythritol tetraacrylate and UA-A contains 27% by mass pentaerythritol tetraacrylate. Since dipentaerythritol pentaacrylate, CAS 6056-81-2, is diluted with 58 wt. % dipentaerythritol hexaacrylate, UA-II contains 40% by mass dipentaerythritol hexaacrylate; these acrylate diluents are included in the calculation of average acrylate diluent functionality.

TABLE 3A
Example Formulation Ex-1 and Comparative
Experiment Formulations Comp-A to Comp-C.

| | Ex-1 | Comp-A | Comp-B | Comp-C |
|---|---|---|---|---|
| Urethane Acrylate: UA-II | 60 | | | |
| Urethane Acrylate: UA-B | | 60 | | |
| Polyester Acrylate: PA | | | 60 | |
| Epoxy acylate (in 50% | | | | 100 |
| diluent): EA | | | | |
| DPGDA | 40 | 40 | 40 | |
| PI | 2.5 | 2.5 | 2.5 | 2.5 |
| Test Results | | | | |
| Gloss 60° (GU) | 4 | 2 | 2 | 98 |
| Gloss 85° (GU) | 8 | 3 | 4 | 100 |
| Iodine Score | 4 | 1 | 1 | 4 |
| Visual appearance | 5 | 5 | 3 | 5 |
| Mustard Score | 5 | 1 | 2 | 5 |

Example Ex-1 illustrates the combination of matte appearance, at least good iodine resistance and at least good visual appearance enabled by the invention. Comparative Experiments A-C show that this combination cannot be obtained with radiation-curable coating composition which are not according to the present invention. Comparative Experiment C shows that the radiation-curable epoxy acrylate system has very good iodine stain resistance and excellent visual appearance, however a high gloss coating is obtained and thus applying Excimer curing does not induce matting to the extent that a low gloss coating can be obtained.

TABLE 3B
Urethane Acrylate Oligomer Structure: Example Formulations Ex-2
and Ex-3 and Comparative Experiment Formulations Comp-D to Comp-H

| | Ex-2 | Ex-3 | Comp-D | Comp-E | Comp-F | Comp-G | Comp-H |
|---|---|---|---|---|---|---|---|
| UA-I | 60 | | | | | | |
| UA-II | | 60 | | | | | |
| UA-A | | | 60 | | | | |
| UA-B | | | | 60 | | | |
| UA-C | | | | | 60 | | |
| UA-D | | | | | | 60 | |
| UA-E | | | | | | | 60 |
| DPGDA | 40 | 40 | 40 | 40 | 40 | 40 | 40 |
| PI | 2.5 | 2.5 | 2.5 | 2.5 | 2.5 | 2.5 | 2.5 |
| Calculated | 2.3 | 2.8 | 2.4 | 2.0 | 2.0 | 2.0 | 2.0 |
| average | | | | | | | |
| functionality of | | | | | | | |
| acrylate diluents | | | | | | | |
| Urethane | 1690 | 2142 | 818 | 1326 | 8754 | 9798 | 6870 |
| acrylate molar | | | | | | | |
| mass | | | | | | | |
| Urethane | 6 | 10 | 6 | 2 | 2 | 4 | 15 |
| acrylate | | | | | | | |
| functionality | | | | | | | |
| Acrylate | 3.6 | 4.7 | 7.3 | 1.5 | 0.2 | 0.4 | 2.2 |
| functionality | | | | | | | |
| per molar | | | | | | | |
| mass for the | | | | | | | |
| urethane | | | | | | | |
| acrylate | | | | | | | |
| Test Results | | | | | | | |
| Gloss 60° | 2 | 4 | 7 | 2 | 1 | 1 | 25 |
| (GU) | | | | | | | |
| Gloss 85° | 4 | 8 | 14 | 3 | 2 | 1 | 41 |
| (GU) | | | | | | | |
| Iodine Stain: | 27 | 13 | 4 | 52 | 55 | 50 | 12 |
| Colorimeter Δb | | | | | | | |
| Visual appearance | 5 | 5 | 2 | 5 | 5 | 5 | 2 |

Examples Ex-2 and Ex-3 illustrate the combination of matte appearance, at least good iodine resistance and at least good visual appearance enabled by the invention. Comparative Experiments D-H show that this combination cannot be obtained with radiation-curable coating composition not according to the present invention.

TABLE 3C
Acrylate Diluent Functionality: Example Formulations Ex-4 to
Ex-6 and Comparative Experiment Formulations Comp-I to Comp-K

| | Comp-I | Comp-J | Ex-4 | Ex-5 | Ex-6 | Comp-K |
|---|---|---|---|---|---|---|
| UA-I | 60 | 60 | 60 | 60 | 60 | 60 |
| LA | 40 | 20 | | | | |
| DPGDA | | 20 | 20 | | | |
| TMPTA | | | 20 | 40 | | |
| Di-TMPTA | | | | | 40 | |
| DPHA | | | | | | 40 |
| PI | 2.5 | 2.5 | 2.5 | 2.5 | 2.5 | 2.5 |
| Calculated average | 1.4 | 1.8 | 2.7 | 3.2 | 4.0 | 5.5 |
| functionality of | | | | | | |
| acrylate diluents | | | | | | |
| Test Results | | | | | | |
| Gloss 60° (GU) | 1 | 1 | 4 | 14 | 27 | 92 |
| Gloss 85° (GU) | 2 | 2 | 8 | 23 | 41 | 100 |
| Iodine Stain: | 33 | 38 | 19 | 13 | 15 | 12 |
| Colorimeter Δb | | | | | | |
| Visual appearance | 5 | 5 | 5 | 3 | 3 | 5 |

For all formulations in Tables 3C and 3D: (Ex-4 to Ex-9 and Comp-I to Comp-O): Acrylate functionality per molar mass for the oligomeric urethane acrylate (mol C═C/kg of oligomeric urethane acrylate)=3.6.

Examples Ex-4-6 illustrate the combination of low gloss/matte appearance, at least good iodine resistance and at least good visual appearance enabled by the invention.

Comparative Experiments I-K show that this combination cannot be obtained with radiation-curable coating composition not according to the present invention.

TABLE 3D
Acrylate Diluent Content: Example Formulations Ex-7 to Ex-9
and Comparative Experiment Formulations Comp-L to Comp-O

| | Comp-L | Comp-M | Ex-7 | Ex-8 | Ex-9 | Comp-N | Comp-O |
|---|---|---|---|---|---|---|---|
| UA-I | 95 | 90 | 80 | 72 | 40 | 20 | 10 |
| DPGDA | 5 | 10 | 20 | 28 | 60 | 80 | 90 |
| PI | 2.5 | 2.5 | 2.5 | 2.5 | 2.5 | 2.5 | 2.5 |
| Calculated | 3.3 | 3.0 | 2.6 | 2.4 | 2.1 | 2.1 | 2.0 |
| average | | | | | | | |
| functionality of | | | | | | | |
| acrylate diluents | | | | | | | |
| Test Results | | | | | | | |
| Gloss 60° (GU) | 9 | 7 | 4 | 3 | 2 | 2 | 2 |
| Gloss 85° (GU) | 16 | 13 | 6 | 6 | 5 | 4 | 3 |
| Iodine Stain: | 33 | 34 | 32 | 28 | 21 | 18 | 19 |
| Colorimeter Δb | | | | | | | |
| Visual appearance | 4 | 4 | 5 | 5 | 5 | 2 | 1 |

Examples Ex-7-9 illustrate the combination of matte appearance, at least good iodine resistance and at least good visual appearance enabled by the invention. Comparative Experiments I-K show that this combination cannot be obtained with radiation-curable coating composition not according to the present invention. Of Examples 7 and Comparative Experiment O, photos of the coated panels have been taken showing the visual surface appearance of the coating.

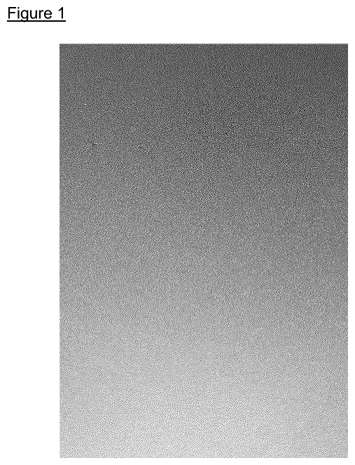

FIG. 1: Example 7—visual appearance rating of 5.

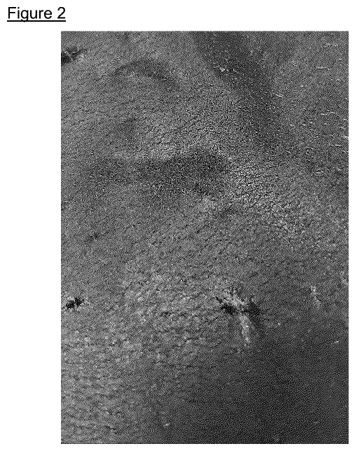

FIG. 2: Comp O—visual appearance rating of 1.

TABLE 3E
Applied Coating Thickness: Examples Ex-10 to Ex-14
The Formulation of Ex-4 was used for examples Ex-10 to Ex-14.

| | Ex-10 | Ex-11 | Ex-12 | Ex-13 | Ex-14 |
|---|---|---|---|---|---|
| Layer Thickness | 6 μm | 12 μm | 24 μm | 50 μm | 100 μm |
| Test Results | | | | | |
| Gloss 60° (GU) | 3 | 3 | 4 | 3 | 3 |
| Gloss 85° (GU) | 6 | 7 | 8 | 4 | 5 |
| Iodine Score | 4 | 4 | 4 | 4 | 4 |
| Visual appearance | 5 | 5 | 5 | 4 | 4 |

Table 3E shows that the inventive product can be applied successfully even at high thicknesses using only two-step cure, while still achieving matte appearance, good iodine resistance, and good surface appearance.

Comparative Experiment Formulation P

The ingredients listed in Table 3F were added into a HDPP jar and mixed thoroughly using a speedmixer (DAC 150.1 FV, Hauschield GmbH) for 2 min @ 3500 rpm. The formulation obtained was applied on a Leneta card (2C Leneta Inc) using a 24 μm wire rod applicator (#3 K bar, RK Printcoat Instruments Ltd), cured and tested as described above.

TABLE 3F
Comparative Experiment Formulation Comp-P

| | Comp-P |
|---|---|
| NeoRad ™ U-6288 | 90.91 |
| Ebecryl ® 5129 | 9.09 |
| PI | 2.50 |
| Test Results | |
| Gloss 60° (GU) | 1 |
| Gloss 85° (GU) | 3 |
| Iodine Score | 0 |
| Visual appearance | 3 |
| Mustard Score | 5 |

This urethane acrylate mixture was disclosed in US 20190077138 in paragraph [0046] in column 4. This urethane acrylate system results in a matte coating with good visual appearance and excellent mustard score, however the coating has very poor iodine resistance. Thus the coating composition does not provide both good excimer matting and at least good iodine resistance.

1. A process for producing a coating, comprising:
(1) irradiating a radiation-curable coating composition with ultraviolet (UV) light having a wavelength ≤220 nm under inert gas, followed by
(2) irradiating the radiation-curable coating composition with UV light having a wavelength ≥300 nm or with an electron beam (E-beam),
wherein the radiation-curable coating composition comprises
(A) one or more oligomeric urethane acrylates (A) with a molar mass of from 1100 to 5000 g/mol and with an acrylate functionality of from 4 to 14, and
(B) one or more acrylate diluents (B) with a molar mass less than 650 g/mol and with an acrylate functionality of from 2 to 4, and
wherein
the amount of (A) is from 20 to 75 wt. % and the amount of (B) is from 25 to 80 wt. %, based on the total amount of (A) and (B), and
the total amount of (A) and (B) is at least 50 wt. % by weight of the radiation-curable coating composition.

2. The process according to claim 1, wherein said one or more oligomeric urethane acrylates (A) have a molar mass of at least 1200 g/mol.

3. The process according to claim 1, wherein said one or more oligomeric urethane acrylates (A) have a molar mass of at most 4000 g/mol.

4. The process according to claim 1, wherein said one or more oligomeric urethane acrylates (A) have an acrylate functionality from 5 to 12.

5. The process according to claim 1, wherein said one or more acrylate diluents (B) have a molar mass of at most 500 g/mol.

6. The process according to claim 1, wherein said one or more acrylate diluents (B) have a molar mass of at least 125 g/mol.

7. The process according to claim 1, wherein said one or more acrylate diluents (B) have an acrylate functionality of 2 or 3.

8. The process according to claim 1, wherein the total amount of (A) and (B) is at least 55 wt. %, by weight of the radiation-curable coating composition.

9. The process according to claim 1, wherein the amount of (A) is from 25 to 73 wt. % and the amount of (B) is from 27 to 75 wt. %, whereby the amounts of (A) and (B) are given relative to the total amount of (A) and (B).

10. The process according to claim 1, wherein said one or more oligomeric urethane acrylates (A) have an acrylate functionality per molar mass higher than 2.4 mol/kg and less than 5.5 mol/kg.

11. The process according to claim 1, wherein the average acrylate functionality of the acrylate diluents present in the radiation-curable coating composition and with a molar mass as defined for (B) is in the range of from 1.9 to 5.3.

12. The process according to claim 1, wherein the radiation-curable coating composition is 100% radiation-curable.

13. The process according to claim 1, wherein the irradiating in step (1) is effected by excimer UV lamps.

14. The process according to claim 1, wherein UV irradiation is applied in step (2) and the radiation-curable coating composition comprises a photo-initiator.

15. The process according to claim 1, wherein the substrate is a flat, non-porous substrate optionally pre-treated with a primer and/or optionally coated.

16. The process according to claim 1, wherein the coating is used in a floor covering, a wall covering or automotive interior or on furniture, on window frames or on façade panels.

17. (canceled)

18. A coated substrate, wherein the coated substrate is obtained by coating a substrate with the process of claim 1.
